(19) United States
(12) Patent Application Publication
(10) Pub. No.: US 2004/0180779 A1
(43) Pub. Date: Sep. 16, 2004

(54) Fired composition and electrodeposition coating

(76) Inventors: Hiroshi Ishikawa, Otsu-shi Shiga (JP); Tsuyoshi Iwamoto, Amagasaki-shi (JP); Kazutoshi Motegi, Kanagawa (JP)

Correspondence Address: Ronald R Santucci, Frommer Lawrence & Haug, 745 Fifth Avenue, New York, NY, 10151, US

(21) Appl. No.: 10/485,631

(22) PCT Filed: Nov. 26, 2002
(86) PCT No.: PCT/JP02/12316

(30) Foreign Application Priority Data
Nov. 26, 2001 (JP) 2001-360076
Mar. 13, 2002 (JP) 2002-67983

(51) Int. Cl. B01J 27/135; C25D 3/56; B01J 23/00; B01J 31/00; C04B 35/46; C04B 14/00; C09C 1/04

(52) U.S. Cl. 502/152; 106/14.05; 106/14.44; 205/245; 205/252; 205/253; 502/227; 502/226; 502/343; 502/352; 501/134; 106/419; 106/425

(57) ABSTRACT

To provide a rust inhibitor which is a fired composition excellent in corrosion resisting properties almost as same as or even better than lead compounds and which is also good in stability of electrodeposition bath. The fired composition is a fired matter of a zinc compound and a tin compound, wherein zinc oxide Wz and tin oxide Ws are in the relation of Wz≧Ws in weight %. The ratio of the zinc oxide Wz and the tin oxide Ws is in the range of 99/1 to 70/30 in weight %, and preferably in the range of 95/5 to 85/15. Such a fired matter has not only a rust resisting function but also a curing catalyst function, so that such a curing catalyst as dibutyl tin oxide, which has heretofore been used, can be eliminated.

### TECHNICAL FIELD

This invention relates to a fired or burned composition having novelty and excellent in rust resisting (rust preventive) or corrosion resisting (corrosion preventive) properties, which can take the place of conventional lead-based compounds. It also relates to an electrodeposition coating material using the fired composition.

### BACKGROUND ART

In general, electrodeposition coating for conducting the coating electrochemically, is excellent in corrosion resisting and throwing power properties and, it is widely used for coating the body of automotive vehicles and their parts, or the like. The coating steps required are, normally, two or three (for example, three steps of under coating, intermediate coating and over coating). In the first step of under coating, adhesion between a coating material and an objective surface is improved and effective rust resisting properties are given. Then, in the following steps of intermediate coating and over coating, a nice-looking coating surface can be obtained. With respect to the general background of electrodeposition coating, reference is made to, for example, Electrodeposition Coating Technique, iron and steel (p.p. 185 through 195, vol. 7, 1980).

The coating material composition used for such electrodeposition coating normally includes, in addition to resin, coloring pigment, rust inhibitor and other additives. When attention is paid to the rust inhibitor, a rust inhibitor, which is most excellent in rust-proof, is a lead compound such as, lead chromate, lead silicate, and lead acetate. Those lead compounds, however, are hazardous and problematical in their use. As low toxic compounds which can take the place of those lead compounds, there are zinc phosphate, zinc molybdate zinc oxide, and so on (see, for example, Japanese Patent Publication No. H03-7224). If a large quantity of those zinc compounds should be used in electrodeposition coating material, the bath coating material would become unstable and electrodeposition resin emulsion would be aggregated to cause an inferior surface of an electrodeposition coating film, etc. and thus not practical.

As a technique for stabilizing the electrodeposition bath, there is known Japanese Patent Application Laid-Open No. H06-200192. In this laid-open publication, there is disclosed a technique for using a titanium oxide pigment obtained by coating a particular quantity of a zinc compound. Another Japanese Patent Application Laid-Open No. H04-325572 discloses a technique for enhancing adhesion to a substrate in which metals such as copper, nickel, zinc, aluminium, tin, iron and the like are used. However, there can be found no idea for applying firing or burning in those related techniques.

Problem to be Solved by the Invention

A primary object of the present invention is to provide a fired composition which is stable in a bath and excellent in corrosion resisting properties almost as same as or even better than lead compounds without using such hazardous compounds as lead compounds and which is also good in stability of electrodeposition bath and in which a zinc compound problematical in stability of electrodeposition bath is not used alone. It is also another object of the present invention to provide an electrodeposition coating material which is excellent in bath stability.

Means for Solving the Problem

After making extensive search and investigation with respect to a method excellent in corrosion resisting properties almost as same as or even better than conventional lead compounds in an electrodeposition coating material and also excellent in electrodeposition bath stability, the present inventors have found that a particular composition matter obtained by firing or burning is useful. That is, they have found that by mixing a particular fired composition obtained by firing a zinc compound and a tin compound in an electrodeposition coating material, and that such a fired composition is excellent in stability of electrodeposition bath. Based on this finding, the present invention has been accomplished.

The fired composition according to the present invention is a fired matter of a zinc compound and a tin compound, wherein zinc oxide Wz and tin oxide Ws are in the relation of Wz≧Ws in weight %. The ratio of the zinc oxide Wz and the tin oxide Ws is in the range of 99/1 to 70/30 in weight %, and preferably in the range of 95/5 to 85/15.

As a zinc compound which can be used in the present invention, there can be listed an organic zinc compound such as zinc acetate, zinc octylate and zinc methacrylate, in addition to an inorganic zinc compound such as zinc oxide, zinc chloride and zinc hydrochloride, and preferably zinc oxide, zinc chloride, and zinc hydrochloride.

As an organic tin compound, there can be listed monobutyl tin chloride, monomethyl tin laurate, dibutyl tin octoate, dioctyl tin laurate, dibutyl tin butylmalate, dioctyl tin octylmalate, tributyl tin octylate, trioctyl tin laurate, tetrabutyl tin, tetraoctyl tin and the like. Although the organic tin compounds are not particularly limited, liquefied compounds are preferable in view of good dispersion. However, even if the compounds are solid at room temperature, there is no problem as long as they can be dissolved in water or solvent.

The fired compound of a zinc compound and an organic tin compound can be manufactured by mixing a zinc compound such as zinc oxide and zinc hydroxide and a liquefied tin compound such as dioctyl tin laurate and dibutyl tin butylmalate with a solvent such as toluene and ethanol, and then, the resultant is fired or burned in an electric furnace at 300 to 1000 degrees C. In case zinc chloride and zinc acetate as a water soluble zinc compound, they can be manufactured by dissolving tin tetrachloride and tin dichloride as an inorganic tin compound in water and then, the resultant is fired or burned in an electric furnace at temperatures in the above-mentioned range.

A fired matter according to the present invention can usefully be used as material of electrodeposition, and more particularly as composition (corrosion inhibitor or rust inhibitor) of a cation electrodeposition coating material, and it can also be provided as an electrodeposition coating material containing the fired matter.

The introduction of the fired matter of the zinc compound and organic tin compound into the electrodeposition coating material composition is not particularly limited. It can be conducted in the same manner as the normal pigment dispersion method. For example, a fired matter of a zinc compound and an organic compound is preliminarily dispersed in a dispersing resin to make a dispersing paste, and then, the dispersing paste thus obtained can be admixed. As a pigment dispersing resin, there can be listed an epoxy-series quaternary ammonium salt type resin, an acryl-series quaternary ammonium salt type resin, and the like which are normally used as a cation electrodeposition coating material.

As a material resin (or main resin), there can be listed one which can be derived from a bisphenol type epoxy resin and having a number average molecular weight of 100 to 10000 and preferably 1000 to 3000, and a base equivalent of the material resin is 40 to 150 (milligram equivalent/100 g) and preferably 60 to 100 (milligram equivalent/100 g).

As a cross linking agent, a block polyisocyanate compound is used. A blocked isocyanate cross linking agent can be obtained by subjecting the blocked agent of isocyanate and multifunctional isocyanate to addition reaction. The block agent of isocyanate is preferably one capable of dissociate the block and regenerate a free isocyanate group when heated to 100 to 200 degrees C. For example, there can be listed caprolactam, phenol, ethasol, 2-ethylhexyl alcohol, butyl cellosolve, methylethyl ketoxime and the like. As a multifunctional isocyanate compound, there can be used fatty acid, alicyclic or aromatic polyisocyanate. For example, there can be listed trilendiisocyanate, xylendiisocyanate, 4, 4-diphenylmethandiisocyanate, hexamethylendiisocyate, isophoronediisocyanate and its isocyanate compound, and the like.

As a curing catalyst, an organic tin compound is used. For example, there can be used dibutyl tin oxide, dioctyl tin oxide, dibutyl tin dilaurate, and the like. The fired matter of zinc compound and tin compound functions not only as a rust inhibitor but also as a curing catalyst. So, the fired matter itself can also be used as a curing catalyst. In that case, the known additive such as dibutyl tin oxide can be omitted. In case the known curing catalyst is omitted, effective corrosion resisting properties can be obtained with a comparatively low baking temperature. The ratio of the main material resin and the blocked isocyanate cross linking agent is 90/10 to 50/50 on a solid basis.

Neutralization and solubilization of the electrodeposition compound according to the present invention are conducted by dispersing main material resin, blocked isocyanate cross linking agent in an aqueous medium using an organic acid such as formic acid, acetic acid, propionic acid, lactic acid and sulfamic acid as a neutralizer.

The electrodeposition coating material composition according to the present invention can be added, as a coating material additive, further with a pigment such as, for example, titan white, carbon black, talc, clay and silica as a pigment paste after such a pigment is dispersed with a pigment dispersing resin. Other rust resisting pigments such as, for example, aluminum phosphate, aluminum phosphomolybdate and barium metaborate, a surface conditioner, and a coating additive such as an organic solvent can be admixed in accordance with necessity.

Moreover, metal oxide and/or metal hydroxide (these are referred to as the component B) is added in a predetermined ratio to and mixed with the fired composition according to the present invention, that is, a fired composition comprising a fired matter of a zinc compound and a tin compound, wherein zinc oxide Wz and tin oxide Ws are in the relation of Wz≧Ws in weight % (this fired composition is referred to as the component A). By doing so, finishing such as smoothness and luster of the outer appearance of a coating film can be more improved. The ratio of the components A and B is in the range of 0.1 to 20 weight % and preferably 0.5 to 5 weight % based on 100 weight % of the component. As the kind of metal in the component B, there can be listed Mg, Al, Si, Ca, Ba, B, Ga, Fe, Mn, Mo, V, Ti, Zr, and the like. Particularly, the oxides of Mg, Al, Si, Ca and Ba are suitable. As for the component B, oxide and hydroxide can be used either alone or in combination. If used in combination, the ratio of the respective components is not limited. From the view point of conducting the mixing uniformly, the component B is preferably in the form of particle or powder. The diameter of the particle of the component B is suitably in the range of 0.1 to 10 μm. The method of mixing the component B with the component A is not particularly limited, and a wide variety of methods can be applied thereto. For example, there are a method for mixing the component B with the component A in a dry manner and a method for mixing the pulverized component B with the component A in a wet manner. When mixing in a wet manner, the suitable conditions include the temperature, normally, in the range of room temperature to 80 degrees C. and the reaction time in the range of 30 min. to 3 hr. After the reaction is finished, the slurry as a resultant of reaction is filtrated, dried and then pulverized to obtain a target composition.

The electrodeposition coating material composition according to the present invention is coated on the surface of the substrate by cation electrodeposition coating. The cation electrodeposition composition is controlled by deionating water so that the concentration becomes 15 to 25 weight % on a solid basis, and the electrodeposition bath comprising the electrodeposition composition whose pH is conditioned in the range of 5.5 to 7.0 is maintained in the temperature range of 20 to 30 degrees C. The applied voltage is kept in the range of 100 to 400 V.

The film thickness formed using the electrodeposition composition according to the present invention is suitably in the range of 10 to 50 μm. The baking temperature of the coating film is suitably in the range of 150 to 180 degrees C. and the baking time is suitably in the range of 20 to 30 min.

The present invention will be described more specifically hereinafter in the form of manufacturing examples and embodiments.

### MANUFACTURING EXAMPLE 1

95.5 g of zinc oxide, 18.9 g of tetraoctyl tin and 150 g of ethanol were measured and taken into a beaker of 500 ml and mixed for 1 hour at room temperature so as to be slurried. The mixed slurry was transferred into an eggplant type flask and ethanol was removed therefrom under reduced pressure realized by a rotary evaporator. As a result, a mixture of powder of zinc oxide and tetraoctyl tin was obtained. The obtained mixture of powder was raised in temperature in a high-speed temperature raising electric furnace (box furnace 51624 made by Koyo Lindburg K. K.) from room temperature (20 degrees C.) at a temperature increasing speed of 10 degrees C./min and fired or burned at 800 degrees C. for 1 hour. The composition of the obtained fired matter was zinc oxide/tin oxide=94.8/5.2 weight % (theoretical value:zinc oxide/tin oxide=95/5 weight %).

### MANUFACTURING EXAMPLE 2

70.3 g of zinc chloride and 33.7 g of monobutyl tin trichloride were measured and taken in a beaker of 500 ml, and 100 g of ethanol was added thereto and mixed at room temperature for 30 min. The mixed slurry was transferred into an eggplant type flask and ethanol was removed therefrom under reduced pressure realized by a rotary evaporator. As a result, a mixture of powder of zinc chloride and monobutyl tin trichloride was obtained. The obtained mixture of powder was raised in temperature in a high-speed temperature raising electric furnace (box furnace 51624 made by Koyo Lindburg K. K.) from room temperature (20 degrees C.) at a temperature increasing speed of 10 degrees C./min and fired at 600 degrees C. for 2 hours. The composition of the obtained fired matter was zinc oxide/tin oxide=71/29 weight % (theoretical value: zinc oxide/tin oxide=70/30 weight %).

### MANUFACTURING EXAMPLE 3

90 g of zinc oxide, 38.1 g of dibutyl tin butylmalate and 130 g of methanol were measured and taken in a beaker of 500 ml, and mixed at room temperature for 1 hour. The mixed slurry was transferred into an eggplant type flask and methanol was removed therefrom under reduced pressure realized by a rotary evaporator. As a result, a mixture of powder of zinc oxide and dibutyl tin butylmalate was obtained. The obtained mixture of powder was raised in temperature in a high-speed temperature raising electric furnace (box furnace 51624 made by Koyo Lindburg K. K.) from room temperature (20 degrees C.) at a temperature increasing speed of 10 degrees C./min and fired or burned at 1000 degrees C. for 1 hour. The composition of the obtained fired matter was zinc oxide/tin oxide=90.3/9.7 weight % (theoretical value: zinc oxide/tin oxide=90/10 weight %).

### MANUFACTURING EXAMPLE 4

67 g of zinc oxide, 41.7 g of dibutyl tin dilaurate and 160 g of isopropyl alcohol were measured and taken in a beaker of 500 ml, and mixed at room temperature for 1 hour. The mixed slurry was transferred into an eggplant type flask and isopropyl alcohol was removed therefrom under reduced pressure realized by a rotary evaporator. As a result, a mixture of powder of zinc oxide and dibutyl tin dilaurate was obtained. The obtained mixture of powder was raised in temperature in a high-speed temperature raising electric furnace (box furnace 51624 made by Koyo Lindburg K. K.) from room temperature (20 degrees C.) at a temperature increasing speed of 10 degrees C./min and fired at 900 degrees C. for 1.5 hours. The composition of the obtained fired matter was zinc oxide/tin oxide=79.5/20.5 weight % (theoretical value:zinc oxide/tin oxide=80/20 weight %).

### MANUFACTURING EXAMPLE 5

59.5 g of zinc oxide and 36.1 g of dibutyl tin dioctylate were measured and taken in a beaker of 500 ml, and 120 g of toluene was added thereto and mixed at room temperature for 1 hour. The mixed slurry was transferred into an eggplant type flask and toluene was removed therefrom under reduced pressure realized by a rotary evaporator. As a result, a mixture of powder of zinc oxide and dibutyl tin dioctylate was obtained. The obtained mixture of powder was raised in temperature in a high-speed temperature raising electric furnace (box furnace 51624 made by Koyo Lindburg K. K.) from room temperature (20 degrees C.) at a temperature increasing speed of 10 degrees C./min and fired or burned at 800 degrees C. for 1.5 hours. The composition of the obtained fired matter was zinc oxide/tin oxide=85.5/14.5 weight % (theoretical value:zinc oxide/tin oxide=85/15 weight %).

Manufacturing Example of Clear Emulsion

1425 g of Evon 1004 (Merchandise Name manufactured by Yuka Shell Co. Ltd.) was dissolved in 759 g of butylcellosolve and 93 g of diethylamine was dropped thereto at 90 to 100 degrees C. The resultant was kept for 3 hours at 120 degrees C. As a result, an epoxyamine additive having an amine value of 47 was obtained.

Then, 750 g of polyamide resin having an amine value of 100 was dissolved in 321 g of methylisobutylketone and refluxed and dehydrated at 140 to 150 degrees C. to ketiminate the terminal amino group of polyamide resin. The resultant was kept for 4 hours at 150 degrees C. and it was confirmed that no water has leaked out. After the liquid temperature was cooled down to 50 degrees C., the epoxyamine additive was added thereto and kept for 1 hour at 80 degrees C. As a result, an epoxyaminopolyamide adding resin varnish of 70% on a solid basis and having an amine value of 66 was obtained. 102 g of the epoxyaminopolyamide resin varnish and 10 g of 15% acetate were mixed with 28 g of a butylcellolve blocked matter of xylenediisocyanate, and 150 g of deionating water was dropped thereto. As a result, a cation electrodeposition clear emulsion of 33% on a solid basis was obtained.

Synthesizing of Pigment Dispersing Resin

823 g of Epototo YD-128 (epoxy equivalent weight of 187, Merchandise Name, epoxy resin manufactured by Toto Kasei Co., Ltd.), 1045 g of Epototo YD-011 (epoxy equivalent weight of 475, Merchandise Name, epoxy resin manufactured by Toto Kasei Co., Ltd.) and 1025 g of propylene glycol monomethylether were prepared, and heated to 100 degrees C. and then agitated for 1 hour. Thereafter, the resultant was cooled down to 80 degrees. Then, 286 g of diethyaminepropylamine and 231 g of diethanolamine were prepared and kept for 2 hours at 100 degrees C. The resultant was then cooled down to 70 degrees C. The obtained dispersing resin was 70% on a solid basis. This resin was neutralized with acetate so that pH becomes 6.5 at the time of pigment dispersion.

Conditioning of Pigment Paste

The resin with the composition shown in the under-listed table 1 was dispersed, then crushed by a sand mill and then conditioned. As a result, a pigment paste was obtained.

Embodiment

36.8 g of pigment pastes having the mixing types 1 to 5 of the embodiments 1 to 5 and the mixing types 6 to 7 of the comparative examples 1 to 2 as shown in Table 1 was added, while agitating, to 181.8 g of cation electrodeposition clear emulsion which was 33% on a solid basis, and the resultant was diluted with 81.4 g of detonating water. As a result, a cation electrodeposition coating material was obtained.

Coating Test

A cold rolled dull steel sheet of 0.8×150×70 mm treated with zinc phosphate was dipped in the electrodeposition coating materials obtained in the embodiments 1 to 5 and comparative examples 1 to 2 so as to serve as a cathode, and electrodeposition coating was carried out. Electrodeposition condition was 280 V in voltage and a coating film thickness was about 20 μm. After washed in water, the film was baked. Baking of conducted in a gear oven for 20 minutes for each temperature. The test result on the obtained baking film is shown in Table 2.

Bath Stability Test

The electrodeposition materials obtained in the embodiments 1 to 5 and comparative examples 1 to 2 were left heated at 30 degrees C. and after the passage of one month, they were filtrated through a wire net of 400 meshes, the quantity of the electrodeposition materials remained on the wire net was measured. The measured result was evaluated in accordance with the following standard.

⊚: smaller than 5 mg

◯: 6 to 10 mg

Δ: 11 to 80 mg

X: 81 mg or more

Curing Property Test

The coating surface of the electrodeposition coating film baked at each temperature was rubbed with a gauge with methylethylketone impregnated therein reciprocally 20 times and then the outer appearance of the coating surface of the baked coating film was visually observed. The evaluation standard is as follows.

◯: no flaws are on the coating surface

Δ: flaws are on the coating surface

X: coating surface is melted and substrate is visible

Corrosion Resisting Property Test

Cross cutting was applied to the coating surface by a knife and salt water spraying test was carried out 1000 times in accordance with JIS-Z-2731, and evaluation was made based on rust present on the knife cutting part and the swelling width. The evaluation standard was as follows.

The outer appearance of the coating film was visually observed and the result was evaluated.

⊚: rust and swelling width are 1 mm or less from the knife cutting part

◯: rust and swelling width are 1.1 to 2 mm from the knife cutting part

Δ: rust and swelling width are 2.1 to 3 mm from the knife cutting part

X: rust and swelling width are 3.1 mm or more from the knife cutting part

Coating Film Smoothness Test

◯: good

Δ: not good

X: bad

TABLE 1

| | | | | | | Comparative | |
|---|---|---|---|---|---|---|---|
| | Embodiment | | | | | Example | |
| | 1 | 2 | 3 | 4 | 5 | 1 | 2 |
| | Mixing | Mixing | Mixing | Mixing | Mixing | Mixing | Mixing |
| Pigment Paste | Type 1 | Type 2 | Type 3 | Type 4 | Type 5 | Type 6 | Type 7 |
| Pigment Dispersing Resin | 10 | 10 | 10 | 10 | 10 | 10 | 10 |
| Fired Matter of | 2.5 | | | | | | |
| Manufacturing Example 1 | | | | | | | |
| Fired Matter of | | 2.5 | | | | | |
| Manufacturing Example 2 | | | | | | | |
| Fired Matter of | | | 2.5 | | | | |
| Manufacturing Example 3 | | | | | | | |
| Fired Matter of | | | | 2.5 | | | |
| Manufacturing Example 4 | | | | | | | |
| Fired Matter of | | | | | 2.5 | | |
| Manufacturing Example 5 | | | | | | | |
| Dibutyl Tin Oxide | 1.8 | 1.8 | 1.8 | 1.8 | 1.8 | 1.8 | 1.8 |
| Titanium White | 7 | 7 | 7 | 7 | 7 | 7 | 7 |
| Clay | 9 | 9 | 9 | 9 | 9 | 9 | 9 |
| Carbon Black | 1 | 1 | 1 | 1 | 1 | 1 | 1 |
| Zinc Oxide | | | | | | | |
| Tin Oxide | | | | | | | 1 |
| Deionating Water | 30 | 30 | 30 | 30 | 30 | 30 | 30 |
| Bath Stability | ♯ | ♯ | ♯ | ♯ | ♯ | x | ♯ |

TABLE 2

| | | | | | | | Comparative | |
|---|---|---|---|---|---|---|---|---|
| | Embodiment | | | | | | Example | |
| | | 1 | 2 | 3 | 4 | 5 | 1 | 2 |
| | Baking | Mixing | Mixing | Mixing | Mixing | Mixing | Mixing | Mixing |
| Test Item | Temperature | Type 1 | Type 2 | Type 3 | Type 4 | Type 5 | Type 6 | Type 7 |
| Curing Properties | 150 degrees C. | ◯ | ◯ | ◯ | ◯ | ◯ | Δ | Δ |
| | 160 degrees C. | ◯ | ◯ | ◯ | ◯ | ◯ | ◯ | ◯ |
| | 170 degrees C. | ◯ | ◯ | ◯ | ◯ | ◯ | ◯ | ◯ |
| Corrosion Resisting | 150 degrees C. | ◯ | ◯ | ♯ | ◯ | ♯ | x | x |
| Properties | 160 degrees C. | ◯ | ♯ | ♯ | ◯ | ♯ | Δ | x |
| | 170 degrees C. | ♯ | ♯ | ♯ | ♯ | ♯ | ◯ | ◯ |
| Smoothness of | 170 degrees C. | ◯ | ◯ | ◯ | ◯ | ◯ | x | ◯ |
| Coating Film | | | | | | | | |

As apparent from the above test results, the fired composition according to the present invention exhibits excellent function not only in bath stability but also in corrosion resisting properties and coating film smoothness as a rust inhibitor for the electrodeposition coating material.

Moreover, based on the present inventors' finding that the fired composition according to the present invention has both the rust resisting and curing catalyst functions, each similar test was carried out in a manner where dibutyl tin oxide is omitted as a curing catalyst. Each test is the test for the embodiments 6 to 10 of the mixing types 8 to 12. Tables 3 and 4 show the results. In the respective Tables including the above Tables, numerical figures indicating weight per unit. If those numerical figures are converted into weight part (i.e., weight with respect to the mixing as a whole), the respective fired matters according to the manufacturing examples 1 to 5 exhibit the curing catalyst function when the adding quantity is about 1.8 weight parts or more. They also exhibit the rust resisting function when the adding quantity is 3.0 or more in weight part. In this respect, according to the experiments, in case the respective fired matters of the manufacturing examples 1 to 5 are used as a curing catalyst and a rust inhibitor and dibutyl tin oxide is not added as a curing catalyst, even if the quantity of the adding fired matter itself is made comparatively small compared with the case where dibutyl tin oxide is added, the similar bath stability and curing property can be provided. The corrosion resisting properties are also excellent even in the case where the baking temperature is lowered (150 to 160 degrees C.).

TABLE 3

| | Embodiment | | | | |
|---|---|---|---|---|---|
| | 6 | 7 | 8 | 9 | 10 |
| | Mixing | Mixing | Mixing | Mixing | Mixing |
| Pigment Paste | Type 8 | Type 9 | Type 10 | Type 11 | Type 12 |
| Pigment Dispersing | 10 | 10 | 10 | 10 | 10 |
| Resin | | | | | |
| Fired Matter of | 1.8 | | | | |
| Manufacturing | | | | | |
| Example 1 | | | | | |
| Fired Matter of | | | | 2.5 | |
| Manufacturing | | | | | |
| Example 2 | | | | | |
| Fired Matter of | | 1.8 | | | |
| Manufacturing | | | | | |
| Example 3 | | | | | |
| Fired Matter of | | | | | 2 |
| Manufacturing | | | | | |
| Example 4 | | | | | |
| Fired Matter of | | | 1.8 | | |
| Manufacturing | | | | | |
| Example 5 | | | | | |
| Dibutyl Tin Oxide | | | | | |
| Titanium White | 7 | 7 | 7 | 7 | 7 |
| Clay | 9 | 9 | 9 | 9 | 9 |
| Carbon Black | 1 | 1 | 1 | 1 | 1 |
| Zinc Oxide | | | | | |
| Tin Oxide | | | | | |
| Deionating Water | 30 | 30 | 30 | 30 | 30 |
| Bath Stability | ♯ | ♯ | ♯ | ♯ | ♯ |

TABLE 4

| | Embodiment | | | | | |
|---|---|---|---|---|---|---|
| | | | 7 | 8 | 9 | 10 |
| | Baking | 6 Mixing | Mixing | Mixing | Mixing | Mixing |
| Test Item | Temperature | Type 8 | Type 9 | Type 10 | Type 11 | Type 12 |
| Curing Properites | 150 degrees C. | ◯ | ◯ | ◯ | ◯ | ◯ |
| | 160 degrees C. | ◯ | ◯ | ◯ | ◯ | ◯ |
| | 170 degrees C. | ◯ | ◯ | ◯ | ◯ | ◯ |
| Corrosion Resisting | 150 degrees C. | ♯ | ♯ | ♯ | ♯ | ♯ |
| Properties | 160 degrees C. | ♯ | ♯ | ♯ | ♯ | ♯ |
| | 170 degrees C. | ♯ | ♯ | ♯ | ♯ | ♯ |
| Smoothness of | 170 degrees C. | ◯ | ◯ | ◯ | ◯ | ◯ |
| Coating Film | | | | | | |

Moreover, in the electrodeposition coating material obtained by mixing a predetermined component B with a particular component A which is the basis of the present invention, smoothness of the coating film can be further improved. Manufacturing examples of the component A and specific examples using the component B will be described next. Through those manufacturing examples and specific examples, it will be understood that the outer appearance of the coating film can be improved by mixing the component B with the component A,

Manufacturing Example of Composition Containing Component B

### MANUFACTURING EXAMPLE 6

### Dry Type Mixture

A composition was obtained by mixing 1 g of magnesium oxide with 100 g of a fired matter of a zinc compound and a tin compound.

### MANUFACTURING EXAMPLE 7

### Dry Type Mixture

A composition was obtained by mixing 5 g of aluminum oxide with 100 g of a fired matter of a zinc compound and a tin compound.

### MANUFACTURING EXAMPLE 8

### Wet Type Mixture

A composition was obtained by mixing 3 g of aluminum hydroxide with 100 g of the fired matter of a zinc compound and a tin compound according to the manufacturing example 5, agitating the same for about 3 hours and then, dehydrating, drying and crushing the same.

### MANUFACTURING EXAMPLE 9

### Dry Type Mixture

A composition was obtained by mixing 3 g of silicon oxide with 100 g of the fired matter of a zinc compound and a tin compound according to the manufacturing example 5.

Manufacturing Example of Electrodeposition Material Using Composition Containing Component B

A cation electrodeposition coating material (i.e., electrodeposition coating material not containing the component B) was manufactured using the fired composition according to the manufacturing example 5 and based on the mixing type 5. Also, cation electrodeposition coating materials (i.e., electrodeposition coating material containing the component B) were manufactured using the fired compositions according to the manufacturing examples 6 to 9. With respect to the last mentioned respective electrodeposition coating materials, cation electrodeposition coating materials were obtained by adding, while agitating, 18.4 g of the pigment pastes according to the embodiments 11 to 14 having the mixing types 11 to 14 shown in Table 5 to 91 g of cation electrodeposition clear emulsion which is 33% on a solid basis, and then, diluting the same with 41 g of deionating water.

TABLE 5

| | Embodiment | | | | |
|---|---|---|---|---|---|
| | 5 | 11 | 12 | | |
| | Mixing | Mixing | Mixing | 13 Mixing | 14 Mixing |
| Pigment Paste | Type 5 | Type 11 | Type 12 | Type 13 | Type 14 |
| Pigment Dispersing | 10 | 10 | 10 | 10 | 10 |
| Resin | | | | | |
| Fired Matter of | 2.5 | | | | |
| Manufacturing | | | | | |
| Example 5 | | | | | |
| Fired Matter of | | 2.5 | | | |
| Manufacturing | | | | | |
| Example 6 | | | | | |
| Fired Matter of | | | 2.5 | | |
| Manufacturing | | | | | |
| Example 7 | | | | | |
| Fired Matter of | | | | 2.5 | |
| Manufacturing | | | | | |
| Example 8 | | | | | |
| Fired Matter of | | | | | 2.5 |
| Manufacturing | | | | | |
| Example 9 | | | | | |
| Dibutyl Tin Oxide | 1.8 | 1.8 | 1.8 | 1.8 | 1.8 |
| Titanium White | 7 | 7 | 7 | 7 | 7 |
| Clay | 9 | 9 | 9 | 9 | 9 |
| Carbon Black | 1 | 1 | 1 | 1 | 1 |
| Deionating Water | 30 | 30 | 30 | 30 | 30 |
| Bath Stability | ♯ | ♯ | ♯ | ♯ | ♯ |

Table 6 shows the test results of the above-mentioned various kinds of test, i.e., curing properties, corrosion resisting properties and smoothness of the coating films, carried out with respect to the electrodeposition coating films. It is understood that the respective electrodeposition coating materials according to the embodiments 11 to 14 containing the component B are especially excellent in smoothness of the coating film compared with the electrodeposition coating material of the embodiment 5 containing no component B. The symbols used in this Table 6 indicate the same things as already mentioned. In particular, the symbol © indicates “excellent” in smoothness of the coating film and much better than the symbol ◯ which indicates “good”.

TABLE 6

| | Embodiment | | | | | |
|---|---|---|---|---|---|---|
| | | 5 | 11 | 12 | 13 | |
| | Baking | Mixing | Mixing | Mixing | Mixing | 14 Mixing |
| Test Item | Temperature | Type 5 | Type 11 | Type 12 | Type 13 | Type 14 |
| Curing Properties | 150 degrees C. | ◯ | ◯ | ◯ | ◯ | ◯ |
| | 160 degrees C. | ◯ | ◯ | ◯ | ◯ | ◯ |
| | 170 degrees C. | ◯ | ◯ | ◯ | ◯ | ◯ |
| Corrosion Resisting | 150 degrees C. | ♯ | ♯ | ♯ | ♯ | ♯ |
| Properties | 160 degrees C. | ♯ | ♯ | ♯ | ♯ | ♯ |
| | 170 degrees C. | ♯ | ♯ | ♯ | ♯ | ♯ |
| Smoothness of | 170 degrees C. | ◯ | ♯ | ♯ | ♯ | ♯ |
| Coating Film | | | | | | |

1. A fired composition comprising a fired matter of a zinc compound and a tin compound, wherein zinc oxide Wz and tin oxide Ws are in the relation of Wz≧Ws in weight %.

2. A fired composition according to claim 1, wherein a ratio of said zinc oxide Wz and said tin oxide Ws is in the range of 99/1 to 70/30 in weight %.

3. A fired composition according to claim 1, wherein said fired composition is a rust inhibitor and/or curing catalyst.

4. A fired composition according to claim 1, wherein said zinc compound is zinc oxide and/or zinc chloride.

5. A fired composition according to claim 1, wherein said tin compound is an organic tin compound, tin tetrachloride and/or tin dichloride.

6. A fired composition according to claim 1, wherein the firing temperature is in a range of 300 to 1000 degrees C.

7. A fired composition according to claim 5, wherein said organic tin compound is one selected from the group consisting of a monoalkyl tin compound, a dialkyl tin compound, a trialkyl tin compound and a tetraalkyl tin compound.

8. A fired compound according to claim 7, wherein an alkyl radical of said tin compound is one selected from the group of methyl, butyl, octyl and lauryl.

9. An electrodeposition coating material having a rust inhibitor contained in a coating material composition thereof, wherein said rust inhibitor is a fired matter of a zinc compound and a tin compound and zinc oxide Wz and tin oxide Ws are in the relation of Wz≧Ws in weight %.

10. An electrodeposition coating material having a fired composition serving as a rust inhibitor and also as a curing catalyst and contained in a coating material composition, wherein said fired composition comprises a fired matter of a zinc compound and a tin compound and zinc oxide Wz and tin oxide Ws are in the relation of Wz≧Ws in weight %.

11. An electrodeposition coating material having corrosion resisting properties, wherein the composition of said coating material includes the under-listed components (A) and (B), and the content of said component (B) is in the range of 0.1 to 20 weight % based on 100 weight % of said component (A);
(A) a fired composition comprising a fired matter of a zinc compound and a tin compound, in which zinc oxide Wz and tin oxide Ws are in the relation of Wz≧Ws in weight %.
(B) a metal oxide and/or metal hydroxide.
